(19) United States
(12) Patent Application Publication
(10) Pub. No.: US 2025/0356649 A1
(43) Pub. Date: Nov. 20, 2025

(54) END-TO-END DIFFERENTIABLE FIN FISH BIOMASS MODEL

(71) Applicant: TidalX AI Inc., Mountain View, CA (US)

(72) Inventors: Grace Calvert Young, Mountain View, CA (US); Yangli Hector Yee, Mountain View, CA (US)

(21) Appl. No.: 19/283,148

(22) Filed: Jul. 28, 2025

Related U.S. Application Data
(63) Continuation of application No. PCT/US2024/013345, filed on Jan. 29, 2024.
(60) Provisional application No. 63/482,206, filed on Jan. 30, 2023.

(51) Int. Cl. G06V 20/05; G06T 5/80; G06T 7/62; G06T 7/80; G06V 10/764; G06V 10/766; G06V 10/776; G06V 10/82

(52) U.S. Cl. CPC G06V 20/05; G06T 5/80; G06T 7/62; G06T 7/85; G06V 10/764; G06V 10/766; G06V 10/776; G06T 2207/10012; G06T 2207/20081; G06T 2207/20084; G06V 10/82

(57) ABSTRACT

Methods, systems, and apparatus, including computer programs encoded on a computer storage medium, that obtain fish images from a camera device and generate predicted values by providing one or more of the fish images to an end-to-end model. The end-to-end model is trained to estimate weight of fish from the fish images and includes one or more differentiable layers configured to adjust one or more parameters of the end-to-end model. By comparing the predicted values to ground truth data representing weights of one or more fish, one or more parameters of the end-to-end model can be updated based on the comparison of the predicted values.

### CROSS-REFERENCE TO RELATED APPLICATIONS

This application is a continuation and claims the benefit of International Application No. PCT/US2024/013345, filed on Jan. 29, 2024, which claims the benefit of U.S. Provisional Application No. 63/482,206, filed on Jan. 30, 2023, the contents of which are incorporated herein by reference in their entirety.

### FIELD

This specification generally relates to estimating biomass of fish in aquaculture environments.

### BACKGROUND

Aquaculture involves the farming of aquatic organisms, such as fish, crustaceans, or aquatic plants. Biomass estimation of fish in aquaculture environments is a critical function in sustainable and efficient fish farming. Estimating the biomass of fish can be highly dependent on fish species, maturity, health, and other types of observable data captured in aquaculture environments.

### SUMMARY

In general, innovative aspects of the subject matter described in this specification relate to estimating, predicting, and determining biomass of fish in an aquaculture pen using stereo pairs of images processed by a trained end-to-end differentiable model. The trained end-to-end differentiable model can receive images of fish and directly estimate the biomass of the fish in the image using a multi-layer neural network. Each layer of the neural network is differentiable, enabling the trained end-to-end model to improve performance of tasks typically associated with biomass estimation without compromising the overall accuracy of the biomass estimate. Using the differentiability of the layers, the trained end-to-end differentiable model adjusts parameters across all differentiable layers to provide a holistic approach for biomass estimation. Furthermore, the trained end-to-end differentiable model can learn relationships mapping portions of received images to estimates for biomass of fish represented in the portions of images, based on adjusted parameters for each differentiable layer.

Biomass estimation provides important information for aquaculture farmers, by providing insights regarding fish health, catch quality, survival rates, quantity, growth, and welfare. To enable aquaculture farming as an effective practice for protein replacement, accurate biomass estimation techniques are important to inform farmers making decisions regarding feeding and raising fish. Some approaches for estimating biomass of fish include techniques that use a number of machine learning models to estimate biomass from images, by performing a sequence of tasks. These approaches may use a data processing pipeline for processing image data using a separate model for each task in biomass estimation, training multiple non-differentiable models to optimize a respective task in the sequence of tasks. Each model of the respective task typically requires its own training and introduces significant computational load and complexity to the overall biomass estimation process. Model adjustments and parameter tuning may also present issues by generating possible downstream effects when a single model in the data processing pipeline adjusts its own set of parameters separately. This can result in unwanted adjustments in the other models of the data processing pipeline and degrade the overall accuracy of biomass estimates.

An end-to-end differentiable model for biomass estimation can provide numerous advantages in improving biomass estimation accuracy, jointly optimizing parameters across multiple layers, reducing computational complexity, and increasing computational savings. For example, individual tasks that are performed with non-differentiable models can instead be performed using the differentiable layers of the end-to-end differentiable model, providing fish species independent estimates of biomass. The end-to-end differentiable model can be trained to perform direct estimation of biomass from pixels of images using a single shared set of training data, as opposed to performing multiple operations and tasks that each need a respective set of training data. Furthermore, the end-to-end differentiable model can account for un-modeled effects that are learned in one differentiable layer to adjust the weights in other layers in which the un-modeled effects may not be observed.

In an aspect, the subject matter described in this specification can be embodied in methods that include the actions of obtaining fish images from a camera device; generating predicted values by providing one or more of the fish images to an end-to-end model trained to estimate weight of fish from the fish images, wherein the end-to-end model includes one or more differentiable layers configured to adjust one or more parameters of the end-to-end model; comparing the predicted values to ground truth data representing weights of one or more fish; and updating the one or more parameters of the end-to-end model based on the comparison of the predicted values.

The foregoing and other embodiments can each optionally include one or more of the following features, alone or in combination.

In some implementations, the method includes providing the predicted values of the end-to-end model to one or more devices and performing an action upon receipt of the predicted values, in which the action configures the one or more devices. The action can include adjusting a feeding system.

In some implementations, the predicted values can include one or more values indicating a weight of a fish represented by the fish images. The fish images can include two images from a pair of stereo cameras of the camera device.

In some implementations, the generating the predicted values can include identifying, from each image of the two images, one or more two-dimensional (2D) features of one or more fish captured in the two images; determining respective sets of 2D coordinates corresponding to the one or more 2D features; generating, using the two images, a rectified image that accounts for distortion in the images; determining, for each of at least a subset of the sets of 2D coordinates, a corresponding set of rectified 2D coordinate in the rectified image; determining, based on a re-projection error between the sets of 2D coordinates and the corresponding sets of rectified 2D coordinates, respective sets of three-dimensional (3D) coordinates corresponding to the one or more 2D features; estimating, by the end-to-end model, a biomass for the one or more fish captured in the two images, wherein estimating the biomass of a respective fish includes determining a density value and a volume value based on one or more pairwise distances among the sets of 3D coordinates.

In some implementations, generating the predicted values can include identifying one or more fish in each of the two images and determining, from each image of the two images, one or more two-dimensional features of the one or more identified fish, wherein each two-dimensional feature of the one or more two-dimensional features is a two-dimensional representation of a feature of a corresponding fish. The method can include determining a plurality of two-dimensional coordinates, wherein each two-dimensional coordinate is associated with a corresponding feature of the one or more two-dimensional features,

generating a rectified image using the two images, wherein the rectified image accounts for distortion, and determining, for each of at least a subset of the two-dimensional coordinates, a respective set of rectified two-dimensional coordinates on the rectified image. The method can also include computing, for the rectified two-dimensional coordinates of the one or more two-dimensional features, a re-projection error between the corresponding set of two-dimensional coordinates and the set of rectified two-dimensional coordinates, and computing, based on the re-projection error and the rectified two-dimensional coordinates, a plurality of three-dimensional coordinates, wherein the three dimensional coordinates correspond to the one or more two-dimensional features of the one or more identified fish. The method can also include computing, based on the plurality of three-dimensional coordinates, a set of three-dimensional truss lengths for each of the one or more identified fish representing at least one pairwise combination of the plurality of three-dimensional coordinates and estimating, using the end-to-end model, a value for density and a value for volume for each fish of the one or more identified fish, based on the set three-dimensional truss lengths. The method can also include estimating, using the end-to-end model, a value for biomass for each fish of the one or more identified fish, based on the estimated value for density and the estimated value for volume for the respective fish, and providing the estimated value for biomass to one or more devices.

In some implementations, identifying the one or more fish in each image of the two images can include generating one or more bounding boxes for each image, wherein the one or more bounding boxes represent an enclosed region of the respective image with an associated likelihood indicating presence of a fish.

In some implementations, computing the re-projection error between the corresponding two-dimension coordinate and the rectified two-dimensional coordinate can include generating one or more rectified bounding boxes for the rectified image, wherein the one or more rectified bounding boxes represent an enclosed region of the rectified image with an associated likelihood indicating presence of a fish, computing a detection score for each of the one or more rectified bounding boxes, wherein the detection score is based on the associated likelihood indicating presence of the fish, and providing the detection score to the end-to-end model.

In some implementations, the ground truth data includes one or more values that represent a weight of at least one fish from the one or more fish. The ground truth data can be obtained from a system that measures the one or more fish.

In some implementations, the camera device is equipped with locomotion devices for moving within a fish pen.

In some implementations, the end-to-end model is a convolutional neural network that includes the one or more differentiable layers. The comparison of the predicted values and the ground truth data can include determining a regression error between the predicted values and a value of the ground truth data. The end-to-end model can be configured to update the one or more parameters of the model when the regression error exceeds a threshold value.

In some implementations, the end-to-end model is configured to generate an output label representing a size of the fish. The end-to-end model can also be configured to compare the output label representing the size of the fish to a corresponding label of the ground truth data. The end-to-end model can also be configured to update the one or more parameters of the model when the output label does not match the label of the ground truth data.

In some implementations, generating the rectified image can include determining the combination of the two images based on intrinsic properties of the camera device.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

In an aspect, a non-transitory computer-readable medium storing one or more instructions executable by a computer system to perform operations of obtaining fish images from a camera device; generating predicted values by providing one or more of the fish images to an end-to-end model trained to estimate weight of fish from the fish images, wherein the end-to-end model includes one or more differentiable layers configured to adjust one or more parameters of the end-to-end model; comparing the predicted values to ground truth data representing weights of one or more fish; and updating the one or more parameters of the end-to-end model based on the comparison of the predicted values.

In an aspect, a system can include one or more processors, and machine-readable media interoperably coupled with the one or more processors and storing one or more instructions that, when executed by the one or more processors, perform operations that include obtaining fish images from a camera device; generating predicted values by providing one or more of the fish images to an end-to-end model trained to estimate weight of fish from the fish images, wherein the end-to-end model includes one or more differentiable layers configured to adjust one or more parameters of the end-to-end model; comparing the predicted values to ground truth data representing weights of one or more fish; and updating the one or more parameters of the end-to-end model based on the comparison of the predicted values.

The subject matter described in this specification relate to biomass estimation of fin fish, e.g., true fishes distinguishable from other types of aquatic life. The methods described herein may also be used to estimate biomass for other aquatic species that include crustaceans, echinoderms, shellfish, and other animals that do not have identifiable characteristics shared by different species of true fishes.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for biomass estimation using an end-to-end differentiable model.

FIG. 2 is a flow diagram showing an example of a process performed using an end-to-end differentiable model to predict biomass.

FIG. 3 is a flow diagram showing an example of a process for training an end-to-end differentiable model.

FIG. 4 is a diagram illustrating an example of a computing system used for predicting fish biomass by an end-to-end differentiable model.

Like reference numbers and designations in the various drawings indicate like elements.

### DETAILED DESCRIPTION

Fish pens can have various species, sizes, and quantities of fish, sometimes making impractical (or in some cases impossible) for fish farmers to accurately determine fish biomass in aquaculture fish pens. Estimating fish biomass is important in aquaculture farming practices, as the biomass of fish in an aquaculture pen can help determine if the fish are appropriately fed, thereby potentially avoiding the risks of underfeeding or overfeeding fish. Incorrect or inappropriate fish feeding schedules and quantities can lead to significant health problems and issues that reduce the efficiency of aquaculture farms and pens. Estimates of fish biomass can provide aquaculture farmers with an understanding of the trophic structure, e.g., the levels of energy consumption, and reproductive outputs, e.g., the number of fish produced, in the aquaculture pen. Accurate estimates for fish biomass also provide aquaculture farmers valuable information about the status of the fish in aquaculture pen and pen conditions, such as habitat conditions, stock status, fishing pressure, and recruitment success.

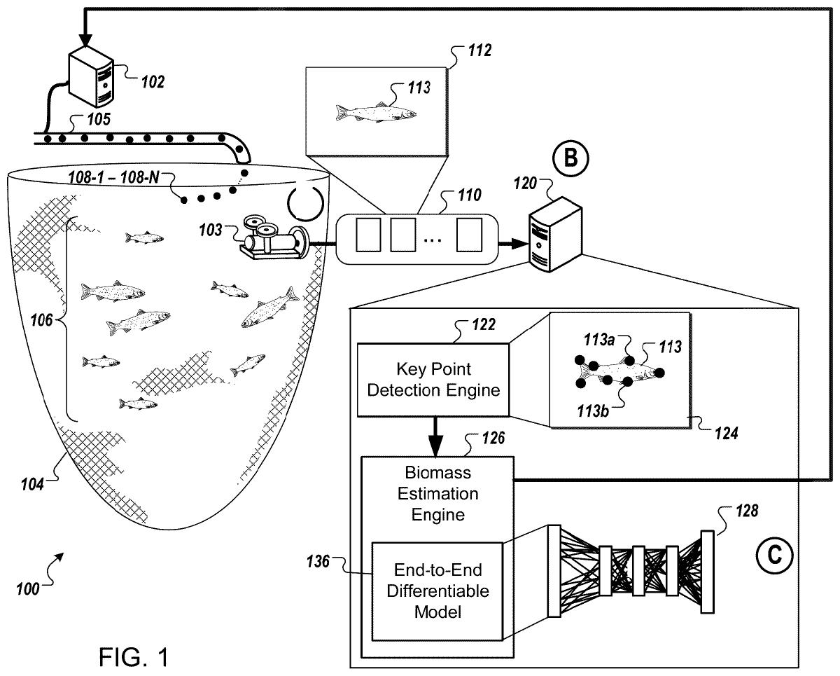

FIG. 1 is a diagram showing an example of a system 100 for estimating biomass using an end-to-end differentiable model. The system 100 includes a camera device 103 and a control unit 102, which may include or operate a feed controller unit 105 that controls the feed 108-1-108-N delivered to the fish pen 104. The feed 108-1-108-N include one or more food pellets that may be consumed by fish 106 in the fish pen 104. The control unit 102 can include components configured to send control messages to actuators, blowers, conveyers, switches, or other components of the system 100. The control messages can be configured to stop, start, or change a meal e.g., number of pellets and frequency of feed 108-1-108-N provided to fish 106 in the fish pen 104.

In general, one or more computing devices 120 (represented herein as a single computing device 120 for brevity) trains an end-to-end differentiable model 136 using ground truth measurements for weights of fish and respective images of the fish with known weights. The computing device 120 can train the end-to-end differentiable model 136 to predict a biomass of an imaged fish. The computing device 120 obtains images from the camera device 103 and provides data based on the obtained images to the end-to-end differentiable model 136. Output of the end-to-end differentiable model 136 can indicate a given feature for an imaged fish, such as biomass, volume, density, and weight of the imaged fish or multiple fish in the image. In some implementations, the computing device 120 may receive data from the control unit 102.

In stage A, the computing device 120 obtains data 110 from the camera device 103. The camera device 103 can be configured with motors or attachments for winches to be able to move around the fish pen 104 and image the fish 106 inside the fish pen 104. The data 110 includes images of fish, such as the image 112 of the fish 113. For example, the data 110 can include captured stereo pairs of images that can be immediately processed, or stored for later processing, depending on processing bandwidth and current, or projected, processing load.

In stage B, the computing device 120 provides data to a key point detection engine 122. The data can include the image 112 or data representing the image 112. The key point detection engine 122 detects one or more key points (also referred to as “keypoints”), e.g., points 113a and 113b, on the fish 113 representing specific locations or portions of the fish 113. Location can include locations of body parts such as fins, eyes, gills, nose, among others. The key points can be two-dimensional (2D) key points based on the images (e.g., a stereo pair of images), which can be used to generate three-dimensional (3D) representations of keypoints representing the same key points but in 3D space.

The key point detection engine 122 provides data to a biomass estimation engine 126. The biomass estimation engine 126 generates a biomass estimation using the end-to-end differentiable model 136, which may be trained using ground truth data such as known weights of previously imaged fish. The end-to-end differentiable model 136 includes a machine learning network 128 with differentiable layers that can update parameters to improve estimates of the model. The biomass estimation engine 126 operates the end-to-end differentiable model 136, which can use the machine learning network to generate estimates for biomass, e.g., weight, volume, density, and so on. The machine learning network 128 can be partially trained, not trained, or fully trained. The machine learning network 128 can include one or more layers with values connecting the one or more layers to generate output from input based on successive operations performed by each layer of the machine learning network 128.

In some implementations, the biomass estimation engine 126 includes stereo matching and triangulation processing. For example, the camera device can include one or more cameras, such as one or more stereo camera pairs, to capture images from multiple perspectives. The biomass estimation engine 126 can use key points identified by the key point detection engine 122 in both images from a stereo image pair and match the two dimensional key points, e.g., in image coordinates, from the cameras and generate an approximate three dimensional location of those points. The data 110 can include depth perception to help the stereo matching and triangulation processing.

In some implementations, the key point detection engine 122 determines three dimensional key points using one or more images. For example, the key point detection engine 122 can combine stereo image pairs to determine a location of key points in three dimensions. In some implementations, the key point detection engine 122 generates three dimensional key points using non stereo image pairs. For example, the key point detection engine 122 can provide one or more images to an end-to-end differentiable model trained to estimate three dimensional key points based on obtained images. The key point detection engine 122 can provide generated 3D key points to the biomass estimation engine 126.

In some implementations, the data provided to the biomass estimation engine 126 includes three dimensional key points. In some implementations, the biomass estimation engine 126 generates three dimensional key points using 2D key points generated by the key point detection engine 122. In some implementations, the biomass estimation engine 126 directly obtains images and provides the images to the end-to-end differentiable model 136. The end-to-end differentiable model 136 can be trained to generate biomass predictions using obtained images of fish.

In some implementations, the biomass estimation engine 126 generates truss lengths for inputting to the end-to-end differentiable model 136. For example, the biomass estimation engine 126 can obtain two dimensional key points detected using the key point detection engine 122 and determine one or more distances between the key points as one or more truss lengths. In some implementations, the biomass estimation engine 126 provides the one or more truss lengths to the end-to-end differentiable model 136 as input. The end-to-end differentiable model 136 can be trained to accept a number of different types of input for generating biomass, or other feature, predictions.

In stage C, the biomass estimation engine 126 provides an estimation generated by the end-to-end differentiable model 136 to the control unit 102. The prediction can include a prediction of any feature that the end-to-end differentiable model 136 is trained to predict, such as biomass, size, volume, density, and so on. The computing device 120 may transmit the estimated biomass to a device (e.g., local device, remote device), such as control unit 102. The control unit 102 can perform an action such as adjusting an amount of feed, a schedule of feed, and so on, in response to receiving a biomass estimation from the end-to-end differentiable model.

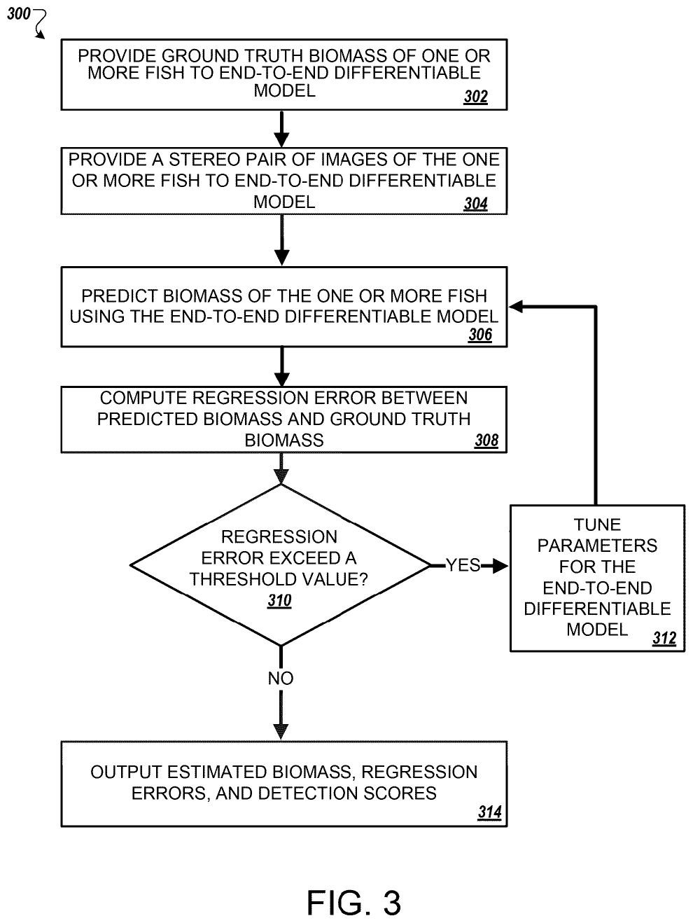

In some implementations, the end-to-end differentiable model 136 adjusts one or more weights or parameters of the differentiable layers in machine learning network 128. In some implementations, parameters of the end-to-end differentiable model 136 are randomly initialized. In some implementations, the end-to-end differentiable model 136 is adjusted using various optimization techniques. Further details of training the machine learning network 128 are described in FIG. 3 below.

In some implementations, the machine learning network 128 of the end-to-end differentiable model 136 includes one or more input layers for truss lengths, one or more hidden layers, and an output layer indicating a prediction based on input. For example, the end-to-end differentiable model 136 can include an input layer for receiving a specific number of truss lengths to define a fish, e.g., 45 trusses. The end-to-end differentiable model 136 can output a weight, e.g., in grams.

In some implementations, the computing device 120 performs one or more operations described as performed by the key point detection engine 122 or the biomass estimation engine 126. In some implementations, the computing device 120 provides data to one or more other processing components to perform operations described as performed by the key point detection engine 122 or the biomass estimation engine 126.

Accurate fish biomass estimation, e.g., as illustrated by the system 100, can support sustainable aquaculture farming practices by providing farmers with insight of feed consumption by the fish in the aquaculture pen. By indicating the presence of overfeeding or underfeeding, an aquaculture farmer or control system for an aquaculture pen can adjust the amount or quantity of feed. Risks of overfeeding fish can include to illnesses such as bloating and diseases such as fatty liver disease, drastically reducing the lifespan of a fish. Overfeeding can also lead to improper digestion, where the fish is unable to receive an appropriate amount of nutrition from the feed. Other health risks of overfeeding fish can include increased fish stress, thereby reducing the quality and quantity of fish catch in an aquaculture pen. Underfeeding fish also poses a risk to fish healthy and production in an aquaculture environment. An underfed fish is more susceptible to illnesses and has a significantly lower rate of recruitment success compared to an appropriately fed fish. Underfeeding fish also results in higher stress levels, thereby resulting in a lower quality of life for the fish.

Unconsumed fish feed can produce harmful byproducts that affect water chemistry and poor water conditions, including lowering pH and oxygen levels and negatively affecting fish habitats. Poor water conditions can also lead to fish developing diseases such as fin rot, significantly reducing the quality of life and lifespan of a fish. Fish habitats such as aquaculture pens are also highly sensitive to the water chemistry in the pen, and resulting increases in nitrite and ammonia levels from feed byproduct can make fish habitats less desirable and less productive for fish farming. Feed byproducts can also create cloudy environments in fish habitats such as aquaculture pens, making it more difficult to observe the fish in the aquaculture pen. When left unmitigated, feed by-product can also accelerate algae bloom in aquaculture pens, releasing harmful toxins to the fish.

Healthy fish and fish welfare play a crucial role in the proliferation of aquaculture farming practices. Healthy fish have a highly beneficial impact on in aquatic environments such as oceans and aquaculture pens by contributing nutrients, thereby supporting marine ecosystems. If left unchecked, diseases and illnesses in fish populations can contaminate food chains and cause disruptions that affect other organisms in the food change, such as humans, flora, and other kinds of fauna. Negative health effects propagate from fish to consumer when the fish are consumed, as the fish are considered poor quality catch. Fewer fish can be farmed when a fish population is affected by illness, disease, poor water quality, and other risks of inappropriate feeding. The utilization of an end-to-end differentiable model to estimate fish biomass in the aquaculture environment can have a positive effect on the health of an entire food chain and provide positive environmental impacts. By providing improved estimations of biomass, the end-to-end differentiable model can improve survival rates, catch quality, and quantity of fish raised in aquaculture environments to help reduce carbon emissions and combat climate change.

FIG. 1 is discussed in stages A through C for ease of explanation. Stages may be reordered, removed, replaced. For example, the system 100 can perform operations described with reference to stage C while obtaining the data 110 from the camera device 103. Components of FIG. 1 can provide and obtain data from other components using one or more wired or wireless networks for communicating data, e.g., the Internet. Although discussed in reference to fish, the techniques described herein may be applied to other animals or articles of manufacture.

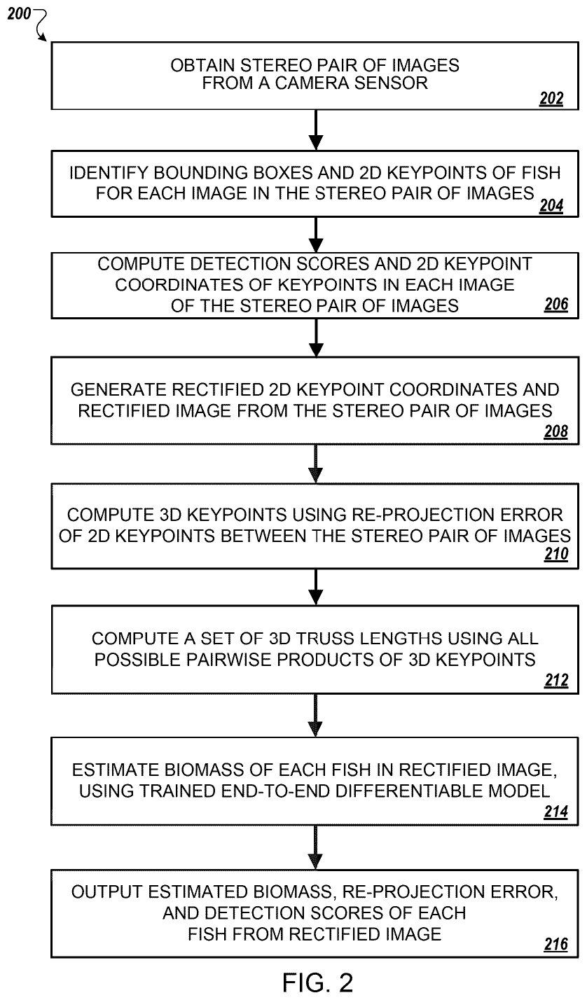

FIG. 2 is a flow diagram showing an example of a process 200 performed by an end-to-end differentiable model to predict biomass. The process 200 may be performed by one or more systems that can include an underwater camera device, coupled with a control unit to process data captured by the underwater camera device. The process 200 is performed by the end-to-end differentiable model, which can be stored on one or more systems, e.g., the underwater camera device, the control unit, one or more remote devices, or some combination therein. As an example, the underwater camera device may include one or more additional sensors, e.g., capturing measurements for temperature, turbidity, conductivity, pressure, to provide to the end-to-end differentiable model. The end-to-end differentiable model is a trained model, e.g., a machine learning model, that can incorporate a variety of training techniques to improve various stages of predicting, estimating, or determining biomass of fish in an aquaculture pen. Stages of end-to-end differentiable model can include object detection, 2D keypoint detection, detection scoring, image and keypoint rectification, 3D keypoint determination, triangulation, and biomass estimation.

An underwater camera device may capture images in an aquaculture pen for the control unit to process using the end-to-end differentiable model. The end-to-end differentiable model may predict an estimate for biomass of one or more fish in the aquaculture pen. The estimated values for biomass from the end-to-end model may be used to perform a control action in the aquaculture pen. For example, the estimated biomass may be used to adjust the control of a feeder system in the aquaculture pen. The estimated biomass can also be used to categorize a specific of fish in the aquaculture, and determine identifying characteristics.

The process 200 includes obtaining a stereo pair of images from a camera sensor (202). The camera sensor can be part of an underwater camera system patrolling an aquaculture pen, capturing one or more scenes in the aquatic environment. The stereo pair of images include a first image, e.g., corresponding to a left image perspective of the stereo pair, and a second image, e.g., corresponding to a right image perspective of the stereo pair. The stereo pair of images include the first and second image, e.g., the left and right image, to capture a wide field-of-view perspective of objects, e.g., a single fish, schools of fish, feed, sea lice, in the aquaculture pen. The stereo pair of images are captured simultaneously, and stored on memory of the underwater camera device or the control unit coupled to the underwater camera device. In some implementations, the stereo pair of images may be extracted from a video recording captured by the camera sensor that includes multiple stereo pairs of images. The stereo pair of images may be pre-processed, e.g., cropped, down-sampled, up-sampled, scaled, by the end-to-end differentiable model prior to predicting the estimated biomass of fish in scene.

The process 200 includes identifying bounding boxes and 2D keypoints of fish in each image of the stereo pair of images (204). In some implementations, the end-to-end differentiable model may generate detections by running a detector, e.g., object detector, pose detector, keypoint detector, feature detector, on the stereo pair of images to identify fish and 2D keypoints in each image. For example, the end-to-end differentiable model may perform object detection to determine and generate bounding boxes around detected objects in each image. Other shapes, including bounding ovals, circles, or the like, can be used to point out detected objects in each image. The end-to-end differentiable model may identify multiple 2D keypoints for each image in the stereo pair of images. Examples of 2D keypoints can include different portions of fish anatomy, e.g., eyes, lips, gill plates, pectoral fins, and peduncles.

The end-to-end differentiable model may generate unique, species-dependent keypoints upon processing the stereo pair of images to determine identified species of fish, based on the estimated biomass. A set of 2D keypoints and identified bounding boxes is generated for each image in the stereo pair of images, e.g., a first set of 2D keypoints and bounding boxes for the left camera image, and a second set of 2D keypoints and bounding boxes for the right camera image. The end-to-end differentiable model may be tuned, e.g., adjusting an operational parameter of a machine learning model, to update object and 2D keypoint detection. In some implementations, the end-to-end differentiable model may perform pose estimation of the fish in an aquaculture scene captured by the stereo pair of images.

The process 200 includes computing detection scores and 2D keypoint coordinates of the 2D keypoints in each image of the stereo pair of images (206). The end-to-end differentiable model computes a detection score indicating the presence of a fish in each of the bounding boxes for each image in a pair of stereo images. For example, a detection score can represent the probability, e.g., a value between 0 and 1 (inclusive), that the object identified in the bounding box is a fish. For example, a detection score with a value close to 0 may indicate that the detected object in the bounding box is very unlikely to be a fish. A detection score with a value close to 1 may indicate that the detected object in the bounding box is likely to be a fish. The end-to-end differentiable model computes 2D coordinates, e.g., a pair of (x, y) coordinates, corresponding to position information for each 2D keypoint identified in each image. In some implementations, the end-to-end differentiable model may compute a series of 2D coordinates in each 2D keypoint in each image. The series, e.g., a grouping, of 2D coordinates may indicate an outline of the identified 2D keypoint in the respective image. In some implementations, the series of 2D keypoints may indicate a region or area on the respective image indicated the presence and spatial location with respect to the image.

The process 200 includes generating rectified 2D keypoint coordinates and a rectified image from the stereo pair of images (208). The end-to-end differentiable model generates a rectified image from the stereo pair of images and a camera matrix. The camera matrix represents intrinsic camera properties, e.g., camera position, camera optical center, camera focal length, which can be used to transform or map the stereo images to a common plane. In some implementations, the camera matrix may include essential matrix or fundamental matrix corresponding to a camera based on the pinhole camera model. The end-to-end differentiable model may estimate a camera matrix based on a stereo pair of images and identify rotations, translations, and transformations to project the stereo pairs of images to a common plane. The common plane and projected stereo pairs of images produce a rectified image with rectified 2D keypoint coordinates. For example, the 2D keypoint coordinates in each image of the stereo pair of images are projected onto the common plane for each 2D keypoint. Algorithms for image rectification performed on the stereo pair of images can include planar, cylindrical, or polar transformations. The end-to-end differentiable model may adjust estimated parameters for intrinsic camera properties, e.g., coordinate transformations, based on training and estimation parameters for biomass or adjustments in tuning parameters for other aspects of biomass estimation, e.g., object detection.

The process 200 includes computing 3D keypoint positions corresponding to the 2D keypoints, based on the re-projection error of 2D keypoint positions between the stereo pair of images (210). The end-to-end differentiable model can generate multiple 3D keypoint positions for each identified fish in the stereo pair of images by computing re-projection errors. A re-projection error may be computed as a distance between a projected point and a measured point in the stereo pair of images. In some implementations, the end-to-end differentiable model may tune parameters or train to improve biomass estimation by minimizing a re-projection error function. For example, the re-projection error may be computed by a differentiable method and a least squares method may be used to compute a sum of re-projection errors, e.g., sum of the absolute values of re-projection errors.

A midpoint method may be used as a differentiable method to compute the re-projection error by determining a series of image points in each image of the stereo pair of images. The series of image points represent features of the image, e.g., 2D keypoints found in the left image and the right image of the stereo pair of images. The 2D keypoints are mapped from a camera image plane representing the rectified image (as discussed above) through the focal point of the camera to a 3D point in space, e.g., representing the 3D keypoint position or coordinates. A pair of projection lines of the image points or 2D keypoints from known intrinsic camera parameters, e.g., camera matrices, can be used to compute a distance for each 3D keypoint position. Each projection line corresponds to an image from the stereo pair of images. An estimated 3D keypoint position is at the midpoint of the shortest line segment joining the two projection lines. A set of 3D keypoint positions map an outline of a detected fish in 3D space, based on the stereo pair of images in two dimensions. Multiple sets of 3D keypoint positions may be determined; each set of the 3D keypoint positions corresponding to a fish identified or detected in the stereo pair of images. The end-to-end differentiable model may use a differentiable method such as the midpoint method to find a maximum response in a region (e.g., of pixels in an image) near a keypoint.

The process 200 includes computing a set of 3D truss lengths using all possible pairwise products of 3D keypoints positions (212). The end-to-end differentiable model computes all spanned 3D truss lengths for a set of 3D keypoints corresponding to a detected fish. For example, a detected fish in a stereo pair of images may have a set of determined 3D keypoints associated with the detected fish. Each pair from all possible pairs, e.g., pairwise combinations, of 3D keypoints are selected to determine a distance spanned between the pair of selected points. After every possible pair of distances are computed, a volume supported by the truss lengths may be generated by the end-to-end differentiable model to represent the volume of the detected fish. An example truss between two separate 3D keypoints can span from one feature, e.g., an eye, to another feature, e.g., lower peduncle, of a fish. In some implementations, the product of all the 3D truss lengths generates an estimated area of a fish in the rectified image.

In some implementations, a number of pairs of 3D keypoints may be omitted if the end-to-end differentiable model determines that the number of pairs of 3D keypoints are unreliable based on received data. For example, the end-to-end differentiable model may determine that some combinations of 3D keypoints provide more valuable data to estimate biomass than other combinations of 3D keypoints. The end-to-end differentiable model may exclude the number of pairs of 3D keypoints, but may also provide the excluded 3D points to other stages of the end-to-end differentiable model to improve biomass estimation accuracy. The exclusion of 3D keypoints, in some implementations, may depend on the species of fish identified by the end-to-end differentiable model. In some implementations, a 3D keypoint may be a series of 3D points representing a feature, e.g., eye, peduncle, dorsal fin leading edge, leading edge of pelvic fin, of a fish. Two keypoints that each include a series of 3D points may be multiplied by each other, multiplying every permutation between the two series of points. By doing so, the entire span of 3D truss lengths can capture an area of the identified fish. As an example, some combinations of 3D keypoints may provide unreliable 3D truss lengths that provide poor data for estimating biomass. The end-to-end differentiable model may exclude a set of 3D keypoints to remove the unreliable 3D truss lengths and improve overall biomass estimation accuracy. For example, short truss lengths from the eye to the mouth of a fish may be less reliable and therefore omitted, compared to longer truss lengths from the mouth to the tail of the fish. In some implementations, the exclusion of keypoints may achieve computational cost savings and improved computational efficiency, e.g., by reducing costs associated with 2D keypoint detection, triangulation, and re-projection.

The process 200 includes estimating biomass of each fish in the rectified image, using the end-to-end differentiable model that is trained to predict fish biomass (214). The end-to-end differentiable model may identify multiple fish in the rectified image and compute area representations of each fish in the rectified image. The end-to-end differentiable model may use a known mass of a single fish based on training data and parameters, to infer the mass of the fish identified in the rectified image. A single fish with known mass in a scene represented by a stereo pair of images captured by an underwater camera system may be referred to as the fish with the highest scoring detections, e.g., a ground truth measurement for the end-to-end differentiable model.

The estimated area of a fish may be processed by a neural network, linear model, etc. of the end-to-end differentiable model to estimate density and volume of the fish, which may be used to compute the mass of the fish. For example, an estimate for biomass can be the product of an estimated density and volume of a fish. The estimated volume of the fish may be represented as a product of width and area. With the estimated area from the product of 3D truss lengths previously determined by the end-to-end differentiable model, the product of density, width, and area may be learned by the end-to-end differentiable model. In some implementations, the end-to-end differentiable model may use a portion or a fraction of the estimated area to estimate mass.

In some implementations, the mass of multiple fish may be used as ground truth measurements to train the end-to-end differentiable model to predict or estimate mass of a single fish. The end-to-end differentiable model can then estimate mass of all of the fish capture in a stereo pair of images. In some implementations, single fish data with known mass may be used to train the end-to-end differentiable model. For example, the end-to-end differentiable model may be provided with a stereo pair of images of the fish represented by the single fish data. The single fish data may include a number of fish and their corresponding e.g., biomass, as measured by another process, e.g., manually by the farmer, additionally camera or weigh systems used in aquaculture pens. The end-to-end differentiable model performance can be scored based on accuracy of the estimated biomass for each fish in the stereo pair of images. In some implementations, the accuracy may be scored within a threshold value determined by the end-to-end differentiable model.

The process 200 includes outputting the estimated biomass, re-projection error, and detection score of each fish from the rectified image (216). The end-to-end differentiable model provides an output of the estimated biomass, with corresponding re-projection errors and detection scores for each fish from the rectified image. The output data of the end-to-end differentiable model may transmitted to a control unit programmed to monitor the biomass of fish in an aquaculture pen. The control unit may perform an action in response to receiving output data from the end-to-end differentiable model, such as adjusting an amount, e.g., increasing, decreasing, of feed provided to the fish in the aquaculture pen. For example, a control unit may provide additional feed to avoid underfeeding fish or reduce the amount of provided feed to avoid overfeeding fish. In some implementations, the end-to-end differentiable model may identify an appropriate feed pattern and schedule to support the estimated biomass of fish in the aquaculture pen. For example, the end-to-end differentiable model may determine appropriate time of day, days of the week, or seasonal patterns to feed the fish with the highest rates of consumed feed, e.g., lowest risk of unconsumed feed in the aquaculture pen.

FIG. 3 is a flow diagram showing an example of a process 300 for training an end-to-end differentiable model to predict biomass. The process 300 may be performed by one or more systems that can include an end-to-end differentiable model with training data that can include training examples. The training examples can include stereo image pairs of fish with known biomass, e.g., a ground truth measurement to be estimated by the end-to-end differentiable model.

The process 300 includes providing ground truth biomass of one or more fish to the end-to-end differentiable model (302). The ground truth biomass may be a measurement of a single known fish, but can also include data representing multiple known fish with a corresponding mass measurement for each fish. In some implementations, the ground truth biomass data may be obtained by manually measuring the fish, using other computing systems or devices to record mass of the fish, and so on.

The process 300 includes providing one or more stereo pairs of images of the one or more fish to the end-to-end differentiable model (304). The stereo pairs of images include one or more fish with known mass measurements. The stereo pairs of images may be provided by one or multiple camera sensors operating in an aquaculture environment, e.g., the cameras are positioned outside of the fish pen. The stereo pairs of images may be stored locally by the end-to-end differentiable model or provided by wireless communication to the end-to-end differentiable model. In some implementations, the end-to-end differentiable model may be coupled to a control unit with a storage device of captured stereo pairs of images. In some implementations, camera sensors may be coupled to an underwater system to acquire the stereo pairs of images. In some implementations, the underwater system is a camera device. The end-to-end differentiable model may be coupled with the camera sensors, however the end-to-end differentiable model may also be stored on one or more computers, systems, or devices remote from the aquaculture pen or camera sensors.

The process 300 includes the end-to-end differentiable model estimating or predicting biomass of one or more fish based on one or more stereo pairs of images (306). The end-to-end differentiable model performs the process 200 described in FIG. 2 to generate a prediction or estimation of the biomass for each fish in the captured stereo pairs of images. In some implementations, the end-to-end differentiable model may perform a subset of the steps described in process 200 based on learned data to reduce computational costs. As an example, the end-to-end differentiable model may process pixel measurements directly without identifying 2D keypoint coordinates. The end-to-end differentiable model may use one or more neural networks, other machine learning models, or some combination therein to generate a prediction or estimation of the biomass in the stereo pairs of images. In some implementations, the end-to-end differentiable model may use categorical labels to identify fish biomass with mass values corresponding to a size, e.g., “small”, “large”, of a fish. In some implementations, the end-to-end differentiable model may provide categorical labels for biomass based on maturity stage, e.g., immature, mature, spawn, or growth stages.

The process 300 includes computing a regression error between the predicted or estimated biomass, and the ground truth biomass (308). The end-to-end differentiable model computes an error between the ground truth biomass and the estimated or predicted biomass. The end-to-end differentiable model may aim to minimize a loss function or error function to achieve an optimal estimate of biomass of fish captured in the scene by the stereo pairs of images. In some implementations, the biomass estimate of the fish may be a categorical label that can be compared with the ground truth. For example, the end-to-end differentiable model may provide an estimate of the growth stage of the fish to compare with the known growth stage of fish previously determined in the ground truth data.

The process 300 includes determining if the regression error between the predicted or estimated biomass exceeds a threshold value (310). The threshold value may be adjusted based on multiple training examples of the end-to-end differentiable model predicting or estimating biomass for multiple species of fish. In some implementations, the comparison of between the predicted or estimated biomass may be a comparison of the categorical label representing fish maturity or growth stage compared to the ground truth label of maturity or growth stage. If the estimated or predicted label for maturity or growth stage matches the ground truth label, the end-to-end differentiable model may process to step 314 described below. If the regression error for the biomass estimate exceeds a threshold error value, or a categorical label is incorrectly estimated by the end-to-end differentiable model, the end-to-end differentiable model may proceed to step 312. Otherwise, if the regression error for the biomass estimate is within a threshold value or a number of categorical labels with respect to the entire known fish ground truth data is met, then the end-to-end differentiable model may proceed to step 312 described below. In some implementations, the threshold error value or number of correctly identified labels associated with fish biomass may be a learned parameter of the end-to-end differentiable model.

The process 300 includes tuning parameters of the end-to-end differentiable model and propagating to various stages of the model, if the regression error exceeds the threshold value (312). The end-to-end differentiable model may adjust weights and parameters associated with various stages of the biomass estimation data processing pipeline. For example, adjusted parameters for 2D keypoint detection, pose estimation, object detection, triangulation, and so on, may be holistically performed by the end-to-end differentiable model to improve biomass estimations. In some implementations, the end-to-end differentiable model performs backpropagation to previous layers in the model to improve biomass estimations. For example, an update can include correcting a misclassified 2D keypoint label to the correct 2D keypoint label. In some implementations, updates to the end-to-end differentiable model can include re-computing intrinsic camera parameters, minimizing re-projection errors, and so on to further improve biomass estimation. Model updates can include adjustments to the image rectification step described in process 200, but can also include other aspects described in process 200 in the specification herein.

The process 300 includes outputting the predicted or estimated biomass, corresponding regression errors and detection scores if the regression error is below the threshold value (314). The output of biomass, regression errors, and detection scores may be provided to a control unit for further action, e.g., to adjust feed amounts for fish in an aquaculture pen. In some implementations, the resulting output of the end-to-end differentiable model may be processed for further testing and validation of the end-to-end differentiable model.

The end-to-end differentiable model may include perform many training updates based on different training examples provided e.g., biomass data and corresponding stereo pairs of images. The end-to-end differentiable model may perform many iterations e.g., millions, of training to gradually and incrementally learn how to make more accurate estimates or predictions for biomass of detected fish. Through the collection of training data from various fish pens and biomass data measurements, the end-to-end differentiable model improve the accuracy of the biomass predictions and estimates over time, learning to accurately estimate and identify features across different fish species and fish stages of developments.

While some methods may optimizing each task in biomass estimation individually, the end-to-end differentiable model optimizes all of the tasks simultaneously. Learned insights for one task can improve the accuracy and performance in other tasks by adjusting certain task-specific parameters. The end-to-end differentiable model can determine which parameters of which tasks need to be adjusted, based on insights and metrics identified from all of the other related tasks in biomass estimation. By doing so, the end-to-end differentiable model can also quickly onboard new specifies of fish for aquaculture farming. Instead of independently training individual models in a data processing pipeline, the end-to-end differentiable model may train all tasks in biomass estimation using the same set of training data.

By using the same set of training data, the end-to-end differentiable model regresses parameters from all tasks to estimate biomass as the objective function, as opposed to regression with multiple objective functions for the multiple tasks associated with biomass estimation. The end-to-end differentiable model may achieve highly accurate results for biomass estimation using fewer training iterations and smaller training datasets than a data processing pipeline without end-to-end differentiability. Using the regression error on a validation test set, the end-to-end differentiable model may also calculate a biomass confidence score to improve training of a classifier used in the end-to-end differentiable model.

In some implementations, the end-to-end differentiable model may perform training to determine how to adjust parameters based on ground truth measurements. For example, the estimated biomass based on one or more processed stereo pairs of images may be compared with a ground truth measurement of biomass for a fish. If the estimated biomass exceeds a threshold value, e.g., an error value, the end-to-end differentiable model can adjust model parameters and repeat processing until the estimated biomass is within the threshold value from the ground truth biomass. In another example, if the identified keypoints for the fish are not within a classified category, e.g., correctly identifying a fin or an example keypoint, then the end-to-end differentiable model can identify features or aspects of the estimation process to adjust parameters. An adjustment of the end-to-end differentiable model may include adjusting the values of weights and biases for nodes in one or more neural networks. In some implementations the end-to-end differentiable model can determine that there are some poses (e.g., when the fish is viewed swimming towards or away from the camera, occluded by other fish) of the fish that are inherently unreliable for biomass estimation. In such circumstances, the end-to-end differentiable model can determine an abstention score to abstain from predicting the biomass of fish whose images are captured under such conditions.

In some implementations, the end-to-end differentiable model may adjust a penalty parameter. In some implementations, parameters adjusted in the end-to-end differentiable model can be learned e.g., by a neural network that can include the end-to-end differentiable model. In some implementations, model parameters adjusted for the end-to-end differentiable model can include coefficients or weights of a neural network, biases of a neural network, and cluster centroids in clustering networks. In some implementations, hyperparameters e.g., parameters to adjust learning of the end-to-end differentiable model, can be adjusted for training the end-to-end differentiable model. Hyperparameters may include a test-train split ratio, learning rates, selection of optimization algorithms, selection of functions e.g., activation, cost, or loss functions, a number of hidden layers, a dropout rate, a number of iterations, a number of clusters, a pooling size, a batch size, and a kernel or filter size in convolutional layers.

The end-to-end differentiable model can use any appropriate algorithm such as backpropagation of error or stochastic gradient descent for training. Through many different training iterations, based on training data and examples provided to the end-to-end differentiable model, the end-to-end differentiable model learns to accurately estimate fish biomass. The end-to-end differentiable model can be trained on time-series stereo image pairs over a time period e.g., hours, days, weeks, and so on. The end-to-end differentiable model is evaluated for error and accuracy over a validation set. The model training continues until either a timeout occurs, e.g., typically several hours, or a predetermined error or accuracy threshold is reached. In some implementations, an ensemble approach of models may be implemented by the end-to-end differentiable model to improve overall accuracy of estimated biomass. Model training and re-training of the end-to-end differentiable model can be performed repeatedly at a pre-configured cadence e.g., once a week, once a month, and if new data is available in the object store then it automatically gets used as part of the training. The data pipeline to obtain new data remains the same as described above.

In some implementations, the end-to-end differentiable model can include feed-forward neural networks with multiple feed-forward layers. Each feed-forward neural network can include multiple fully-connected layers, in which each fully-connected layer applies an affine transformation to the input to the layer, i.e., multiplies an input vector to the layer by a weight matrix of the layer. Optionally, one or more of the fully-connected layers can apply a non-linear activation function e.g., ReLU, logistic, hyperbolic tangent, to the output of the affine transformation to generate the output of the layer. In some implementations, the end-to-end differentiable model can include regression e.g., linear, logistic, polynomial, ridge, LASSO techniques.

The image data, e.g., stereo pairs of images, captured by the underwater camera system may be processed by the end-to-end differentiable model asynchronously, based on processing loads. The image data may be stored for later processing. In some implementations, one or more pairs of stereo images of the image data may be compressed, masked, filtered, or discarded based on image characteristics, e.g., size, image quality, occlusions. In some implementations, one or more pairs of stereo images may be processed, stored, discarded, filtered, compressed, or masked based on end-to-end differentiable model characteristics, e.g., bandwidth, processing loads. The image data may be provided to the end-to-end differentiable model as processing bandwidth becomes available, and in some implementations, the end-to-end differentiable model may be implemented on a cloud-based architecture.

The end-to-end differentiable model may refine estimates for biomass of one or more fish detected in a stereo pair of images. The end-to-end differentiable model may override initial estimates for biomass based on additional training of the model, or upon processing additional stereo pairs of images. The end-to-end differentiable model may include one or more additional models trained to perform several processes included in estimating biomass, e.g., triangulation, image rectification, 2D keypoint estimation, 3D keypoint estimation, detection score computations, and the like. In some implementations, the end-to-end differentiable model may exclude one or more trained models.

The end-to-end differentiable model can perform a variety of training techniques to improve biomass estimation of fish in an aquaculture environment, including supervised and unsupervised learning. In some examples, the end-to-end differentiable model performs hybrid-learning techniques to improve biomass estimation. The training of the end-to-end differentiable model can be performed using obtained ground truth data that includes known fish species, biomass measurements, and keypoints of the fish, coupled with images of the fish. The end-to-end differentiable model can adjust one or more weights or parameters to match estimates or predictions from the end-to-end differentiable model to the ground truth data. In some implementations, the end-to-end differentiable model includes one or more fully or partially connected layers. Each of the layers can include one or more parameter values indicating an output of the layers. The layers of the end-to-end differentiable model can generate biomass estimations for fish in an aquaculture environment, which can be used to perform one or more control actions in the aquaculture pen, e.g., adjusting the feed provided to the fish in the pen.

In some implementations, obscuring, e.g., marine snow, dust, atmospheric effects, among others, degrade the quality of images from a camera sensor. Based on a quality determination, a camera sensor can determine one or more images, and one or more detections for subsequent processing. Quality determination can include processing by end-to-end differentiable model trained to determine one or more values indicating a quality of an image. Quality can indicate the confidence or accuracy of subsequent object detection using that image. The camera can detect an area to extract, or identify an area for processing. In some implementations, the end-to-end differentiable model can be optimized to include enough pixels for accurate image analysis while minimizing image size to reduce storage and increase processing efficiency.

Image data e.g., stereo pairs of images, can be processed asynchronously. For example, if there are many regions of interest in an image, it might not be possible to process all images at once given computational constraints. An image can be saved for processing at a later time (e.g., when there is less computational load on the system). Saving just 10% of an image takes less space than saving 100% of an image. Based on schooling of fish in the pen, images obtained from the camera device may suddenly be filled with fish as a school swims past a camera of the underwater camera system or as the underwater camera system moves past a school. Images of schools of fish, where there may be many areas of interest, may be obtained following or preceding images of empty water. The end-to-end differentiable model described in FIG. 2 can help solve the issue of unequal process requirements of obtained images while reducing storage requirements and decreasing processing time.

The end-to-end differentiable model is also better suited to handle unmodelled effects such as the point spread function of the camera system used to acquire the stereo pairs of images. As an example, the end-to-end differentiable model may propagate the effects of the point spread function across multiple stages or tasks in biomass estimation to improve the estimate accuracy. The end-to-end differentiable model may also improve the accuracy of generated 3D keypoints by performing bundle adjustment, further minimizing re-projection errors when translating 2D keypoint coordinates into 3D keypoint locations in space. For example, the end-to-end differentiable model may jointly optimize one or more 3D keypoints to maintain consistency. Improved consistency in some features of the end-to-end differentiable model may reduce dependencies on other features of the end-to-end differentiable model, resulting in computational savings.

Further computational savings can be achieved when the end-to-end differentiable model performs direct estimation of biomass from pixels of the stereo pair of images. For example, the end-to-end differentiable model can be sufficiently trained for biomass estimation across multiple tasks, such as keypoint detection. The end-to-end differentiable model may learn to skip steps in generating estimates for biomass upon learning optimal parameters and underlying relationships between different tasks. The end-to-end differentiable model may learn that a subset of keypoints should be prioritized, excluding other identified keypoints while processing image data for biomass estimation. The end-to-end differentiable model may learn prioritization of keypoints based on fish species, maturity stages, or other factors that affect fish features. By doing so, the end-to-end differentiable model may achieve significant computational savings by processing a subset of the captured image data from stereo pairs of images. Upon determination of previously hidden dependencies in the various tasks associated with biomass estimation, the end-to-end differentiable model may be tuned to directly estimate biomass from pixels or pixel measurements obtained by the stereo pair of images.

The end-to-end differentiable model may select complex keypoints for a fish and adjust incorrect or inaccurate estimations and provide a correct value or estimate within a threshold value to improve model accuracy. Any differentiable methods can be included in the end-to-end differentiable model, to support tasks in biomass estimation such as fish modeling, pose estimation, keypoint detection, object detection, triangulation, and so on. As an example, improvement in pose estimation of the end-to-end differentiable model can provide improved accuracy in generating truss reconstructions of a detected fish in a scene. Improved truss reconstruction can provide improved accuracy in estimating volume of the fish, and thereby improves the accuracy of estimated biomass due to the relationship between volume and mass.

Any tuned parameters learned in one stage of the biomass estimation pipeline can be propagated to any other stages of the biomass estimation pipeline. By providing a holistic view of the biomass estimation process, the end-to-end differentiable model reduces risks of adjusting parameters for a task having negative downstream effects on other tasks. Parameter tuning in one task can be propagated to other tasks in the end-to-end differentiable model to improve model accuracy. The end-to-end differentiable model replaces stages, tasks, or steps of biomass estimation that are non-differentiable to differentiable, allowing to gradient methods to repeatedly improve the model. For example, adjustments made to the prediction or estimate of biomass at the output of the model can have back-propagated errors at every stage, including the first stage of acquiring stereo pairs of images that include pixel data. Each stage can be adjusted based on learned parameters from any other stage, including the end result for estimated biomass. Improved estimates for other tasks can be achieved by forward passes of the model to evaluate loss functions or back-propagating errors, and backward passes to evaluate model gradients of loss functions to repeatedly update the model to the first layer, e.g., pixels.

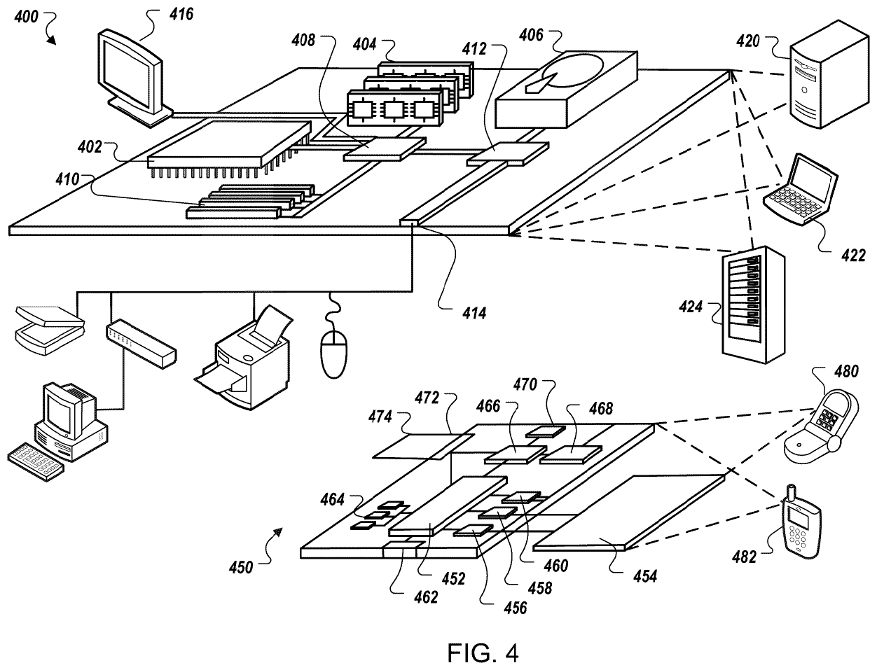

FIG. 4 is a diagram illustrating an example of a computing system used for a model that estimates biomass. The computing system includes computing device 400 and a mobile computing device 450 that can be used to implement the techniques described herein. For example, one or more components of the system 100 could be an example of the computing device 400 or the mobile computing device 450, such as a computer system implementing the control unit 102 or the computing device 120, devices that access information from the control unit 102 or the computing device 120, or a server that accesses or stores information regarding the operations performed by the control unit 102 or the computing device 120.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a Graphical User Interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations e.g., as a server bank, a group of blade servers, or a multi-processor system. In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 e.g., through a graphics processor or accelerator, and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory). In some implementations, instructions are stored in an information carrier such that the instructions, when executed by one or more processing devices e.g., processor 452, perform one or more methods, such as those described above. The instructions can also be stored by one or more storage devices, such as one or more computer or machine-readable mediums e.g., the memory 464, the expansion memory 474, or memory on the processor 452. In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 4G/5G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound e.g., voice messages, music files, among others, and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

In conclusion, these techniques described herein will improve biomass estimation of fish in aquaculture environments, improving overall fish health and well-being. Supporting aquaculture environments and farming practices can provide a sustainable alternative to current farming practices, including cattle farming. Aquaculture is an emerging alternative farming practice to beef cattle farming. Farming fish in aquaculture environments can be a sustainable and suitable protein source replacement to beef, without increasing carbon emissions and thereby mitigating the effects of climate change. For example, the global demand for beef products has led to the rapid deforestation of rainforests to create grazing lands for cattle farming. Deforestation of rainforests leads to increased carbon emissions and reduced carbon sequestration, e.g., trees converting carbon emissions into oxygen, thereby greatly exacerbating climate change.

Aquaculture, however, serves a highly sustainable alternative to raise and farm fish for consumption as a protein substitute to beef. For example, raising and farming fish requires far less feed, e.g., improved feed conversion ratio, compared to raising and farming cattle for beef. Aquaculture also does not have an adverse effect on carbon sequestration and far less carbon emissions compared to cattle farming. Additionally, the water footprint of aquaculture is far more sustainable, e.g., re-usable or recyclable, compared to the water footprint associated with cattle farming. Improved biomass estimation and accuracy correlates to an improvement in efficient fish farming and sustainability. Efficient aquaculture practices can help replace the high demand for beef consumption and reduce carbon emissions, supporting human consumption demands while supporting sustainable marine ecosystems.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data e.g., one or more scripts stored in a markup language document, in a single file dedicated to the program in question, or in multiple coordinated files e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM (erasable programmable read-only memory), EEPROM (electrically erasable programmable read-only memory), and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A method comprising:
obtaining fish images from a camera device;
generating predicted values by providing one or more of the fish images to an end-to-end model trained to estimate weight of fish from the fish images, wherein the end-to-end model comprises one or more differentiable layers configured to adjust one or more parameters of the end-to-end model;
comparing the predicted values to ground truth data representing weights of one or more fish; and
updating the one or more parameters of the end-to-end model based on the comparison of the predicted values.

2. The method of claim 1, comprising:
providing the predicted values of the end-to-end model to one or more devices; and
performing an action upon receipt of the predicted values, in which the action configures the one or more devices.

3. The method of claim 2, wherein the action that configures the one or more devices further comprises adjusting a feeding system.

4. The method of claim 1, wherein the predicted values include one or more values indicating a weight of a fish represented by the fish images.

5. The method of claim 1, wherein the fish images include two images from a pair of stereo cameras of the camera device.

6. The method of claim 5, wherein generating the predicted values comprises:
identifying, from each image of the two images, one or more two-dimensional (2D) features of one or more fish captured in the two images;
determining respective sets of 2D coordinates corresponding to the one or more 2D features;
generating, using the two images, a rectified image that accounts for distortion in the images;
determining, for each of at least a subset of the sets of 2D coordinates, a corresponding set of rectified 2D coordinate in the rectified image;
determining, based on a re-projection error between the sets of 2D coordinates and the corresponding sets of rectified 2D coordinates, respective sets of three-dimensional (3D) coordinates corresponding to the one or more 2D features;
estimating, by the end-to-end model, a biomass for the one or more fish captured in the two images, wherein estimating the biomass of a respective fish comprises determining a density value and a volume value based on one or more pairwise distances among the sets of 3D coordinates.

7. The method of claim 5, wherein generating the predicted values further comprises:
identifying one or more fish in each of the two images;
determining, from each image of the two images, one or more two-dimensional features of the one or more identified fish, wherein each two-dimensional feature of the one or more two-dimensional features is a two-dimensional representation of a feature of a corresponding fish;
determining a plurality of two-dimensional coordinates, wherein each two-dimensional coordinate is associated with a corresponding feature of the one or more two-dimensional features;
generating a rectified image using the two images, wherein the rectified image accounts for distortion;
determining, for each of at least a subset of the two-dimensional coordinates, a respective set of rectified two-dimensional coordinates on the rectified image;
computing, for the rectified two-dimensional coordinates of the one or more two-dimensional features, a re-projection error between the corresponding set of two-dimensional coordinates and the set of rectified two-dimensional coordinates;
computing, based on the re-projection error and the rectified two-dimensional coordinates, a plurality of three-dimensional coordinates, wherein the three-dimensional coordinates correspond to the one or more two-dimensional features of the one or more identified fish;
computing, based on the plurality of three-dimensional coordinates, a set of three-dimensional truss lengths for each of the one or more identified fish representing at least one pairwise combination of the plurality of three-dimensional coordinates;
estimating, using the end-to-end model, a value for density and a value for volume for each fish of the one or more identified fish, based on the set three-dimensional truss lengths;
estimating, using the end-to-end model, a value for biomass for each fish of the one or more identified fish, based on the estimated value for density and the estimated value for volume for the respective fish; and
providing the estimated value for biomass to one or more devices.

8. The method of claim 7, wherein identifying the one or more fish in each image of the two images further comprises generating one or more bounding boxes for each image, wherein the one or more bounding boxes represent an enclosed region of the respective image with an associated likelihood indicating presence of a fish.

9. The method of claim 7, wherein computing the re-projection error between the corresponding two-dimension coordinate and the rectified two-dimensional coordinate further comprises:
generating one or more rectified bounding boxes for the rectified image, wherein the one or more rectified bounding boxes represent an enclosed region of the rectified image with an associated likelihood indicating presence of a fish;
computing a detection score for each of the one or more rectified bounding boxes, wherein the detection score is based on the associated likelihood indicating presence of the fish; and
providing the detection score to the end-to-end model.

10. The method of claim 1, wherein the ground truth data includes one or more values that represent a weight of at least one fish from the one or more fish.

11. The method of claim 1, wherein the camera device is equipped with locomotion devices for moving within a fish pen.

12. The method of claim 1, comprising:
obtaining the ground truth data from a system that measures the one or more fish.

13. The method of claim 1, wherein the end-to-end model is a convolutional neural network that comprises the one or more differentiable layers.

14. The method of claim 1, wherein the comparison of the predicted values and the ground truth data comprises determining a regression error between the predicted values and a value of the ground truth data.

15. The method of claim 14, wherein the end-to-end model is configured to update the one or more parameters of the model when the regression error exceeds a threshold value.

16. The method of claim 1, wherein the end-to-end model is configured to generate an output label representing a size of the fish.

17. The method of claim 16, wherein the end-to-end model is configured to compare the output label representing the size of the fish to a corresponding label of the ground truth data.

18. The method of claim 17, wherein the end-to-end model is configured to update the one or more parameters of the model when the output label does not match the label of the ground truth data.

19. The method of claim 7, wherein generating the rectified image comprises determining the combination of the two images based on intrinsic properties of the camera device.

20. A non-transitory computer-readable medium storing one or more instructions executable by a computer system to perform operations comprising:
obtaining fish images from a camera device;
generating predicted values by providing one or more of the fish images to an end-to-end model trained to estimate weight of fish from the fish images, wherein the end-to-end model comprises one or more differentiable layers configured to adjust one or more parameters of the end-to-end model;
comparing the predicted values to ground truth data representing weights of one or more fish; and
updating the one or more parameters of the end-to-end model based on the comparison of the predicted values.

21. A system, comprising:
one or more processors; and
machine-readable media interoperably coupled with the one or more processors and storing one or more instructions that, when executed by the one or more processors, perform operations comprising:
obtaining, by a camera device, fish images;
generating, by an end-to-end model, predicted values by providing one or more of the fish images to the end-to-end model trained to estimate weight of fish from the fish images, wherein the end-to-end model comprises one or more differentiable layers configured to adjust one or more parameters of the end-to-end model;
comparing the predicted values to ground truth data representing weights of one or more fish; and
updating the one or more parameters of the end-to-end model based on the comparison of the predicted values.
